(19) United States
(12) Patent Application Publication
(10) Pub. No.: US 2010/0175786 A1
(43) Pub. Date: Jul. 15, 2010

(54) GAS PUMP NOZZLE HANDLE BLOCK AND METHOD OF USE

(76) Inventor: Michael Martin, Fort Wayne, IN (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/353,379

(22) Filed: Jan. 14, 2009

(51) Int. Cl. B67D 5/375; B67D 5/37; B65B 3/04; G05G 5/06

(52) U.S. Cl. 141/392; 251/101; 74/523

(57) ABSTRACT

A gas pump nozzle handle block and method of use for maintaining an open flow position until the valve senses the back pressure to shut off the flow of gas, the block dimensioned so as to slide within an opening of the nozzle handle, and rotated within the opening so as to frictionally engage a bottom side of the block against an upper side of the nozzle handle below the opening of the handle and to further frictionally engage an upper side of the block against an undersurface of a valve operating lever and to push the lever toward a lower side of the nozzle handle above the opening of the nozzle handle, thereby maintaining the operating lever in an open flow position until the nozzle valve senses a back pressure to shut off a flow of gas through the nozzle valve.

### FIELD OF THE INVENTION

The invention relates to gas pump nozzle handle use and method of facilitating the maintaining of the nozzle in an open flow position until the nozzle senses the back pressure to shut off the flow of gas through the nozzle.

### BACKGROUND OF THE INVENTION

One common observation around gas filling stations is that many with arthritic hands have a difficult time in squeezing the gas nozzle valve lever to pump the gas in their vehicles.

Gas stations that have nozzles with locking levers may assist those that have problems squeezing the nozzle handle why their gas tank is being filled. But most gas stations have removed the locking mechanism because they often would not disengage upon sensing of the back pressure of the nozzle as the gas tank was approaching maxing fill, due in part to the multiple positions that the end of the locking lever would seat. Often the lever would simply re-seat itself in an adjacent position and gas would continue filling leading to overflow of the gas onto the vehicle and surrounding asphalt surface. This condition can cause a fire in certain circumstances as well as damage to the asphalt surface.

The locking mechanism is a convenience that allows the attendant to do other things, like check the oil, wash the windshield, check tire air pressure, etc. This saves time thereby allowing those in line to get to the pump sooner. However, the lack of a device that performs a function such as a locking mechanism just makes everyone in line wait a significantly longer time to reach the pump.

What is needed is a device that provides for the conveniences discussed above afforded by the locking lever mechanism, while at the same time, eliminating the safety hazard that a locking lever mechanism presents. The present invention also affords a reasonable accommodation to help those inflicted with handicaps to their hands such as arthritis or carpal tunnel syndrome.

### SUMMARY OF THE INVENTION

The present invention is a gas pump nozzle handle block for use in maintaining the nozzle valve in an open flow position until the nozzle valve senses the back pressure to shut off the flow of gas through the nozzle valve. The block comprises a member that has a predetermined width, height and thickness wherein the predetermined height and thickness are dimensioned so as to slide within an opening of a gas pump nozzle handle, and rotated within the opening so as to frictionally engage a bottom side of said member against an upper side of the nozzle handle below the opening of the gas pump nozzle handle and to further frictionally engage an upper side of the member against an undersurface of a nozzle valve operating lever and to push the lever toward a lower side of the nozzle handle above the opening of the gas pump nozzle handle, therein providing the means for maintaining the operating lever in an open flow position until the nozzle valve senses a back pressure to shut off a flow of gas through the nozzle valve.

In a preferred embodiment, the member or block has at least one pair of diagonally opposing rounded corners. Preferably the corners can have an approximate ¼ inch radius but other radii such as about ⅛ inch to about ½ inch are also contemplated. The rounded corners are formed so that upon flipping or rotating of the block, to frictionally engage respective sides of the undersurface of a nozzle valve operating lever and the upper side of the nozzle handle below the opening of the gas pump nozzle handle. Optionally, the block or member can be formed to be more universal by having two pairs of diagonally opposing rounded corners.

The block can be made from a variety of durable materials known in the art such as those materials selected from the group consisting of wood material, plastic material, fiberglass material, and composite polymeric material. Due to the nature of the intended use, it is preferred that any material selected be static free, that is, have non-static characteristics for obvious safety reasons.

An optional embodiment is the providing of handle means extending from one side edge of the block for facilitating an insertion of the block within the opening of the gas pump nozzle handle and for further facilitating a rotation and frictional engagement of the block within the opening of the gas pump nozzle handle.

The invention further includes the method of use of the block, that is, the method of maintaining a gas pump nozzle valve in an open flow position until the nozzle valve senses a back pressure to shut off the flow of gas through the nozzle valve. The method comprises:

providing a gas pump nozzle handle block as described above for use in maintaining the nozzle valve in an open flow position until the nozzle valve senses a back pressure to shut off the flow of gas through the nozzle valve; and

inserting the member within the opening of the gas pump nozzle handle and rotating and frictionally engaging the member within the opening of the gas pump nozzle handle between the upper side of the nozzle handle below the opening of the gas pump nozzle handle and an undersurface of a nozzle valve operating lever and to push the lever toward a lower side of the nozzle handle above the opening of the gas pump nozzle handle to maintain the operating lever in an open flow position until the nozzle valve senses a back pressure to shut off a flow of gas through the nozzle valve.

### BRIEF DESCRIPTION OF THE DRAWINGS

In the accompanying drawings:

FIG. 1A is a representative of an example of a gas pump hand held nozzle with the inventive block inserted for use below the valve operating lever;

FIG. 1B is a the depiction if FIG. 1A with the inventive block rotated in position to hold the operating lever in a valve open position;

FIG. 2A is a depiction of an example of the invention with 4 opposite rounded corners;

FIG. 2B is a depiction of an example of the invention with 2 opposite rounded corners; and

FIG. 3 is a depiction of an optional embodiment where a tab handle is added from the side of the inventive block.

### DETAILED DESCRIPTION OF THE INVENTION

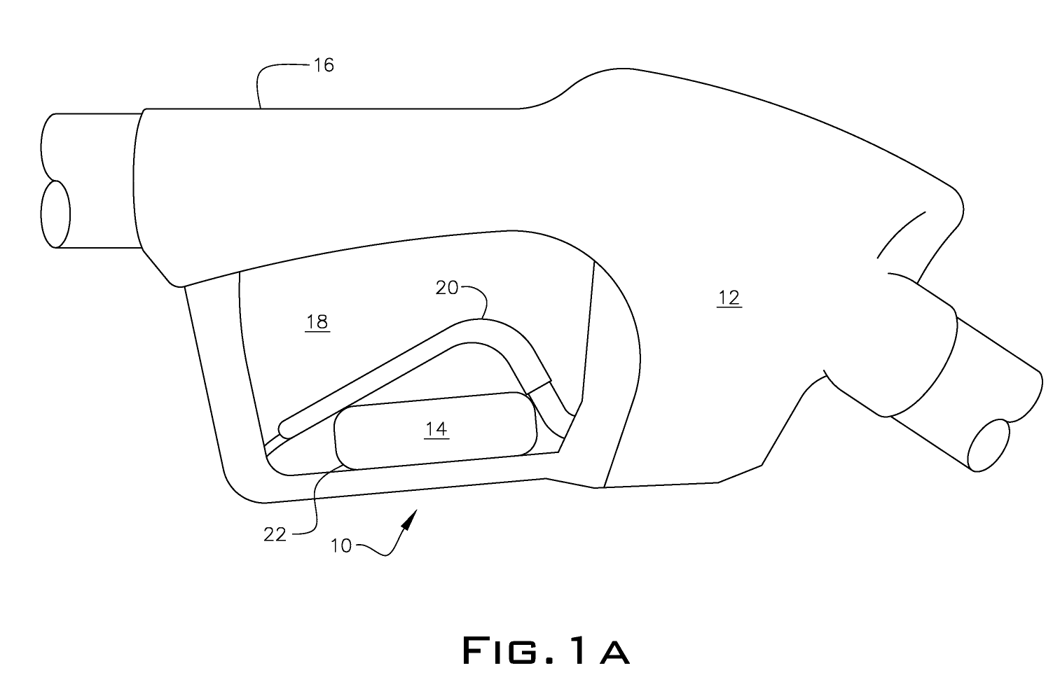

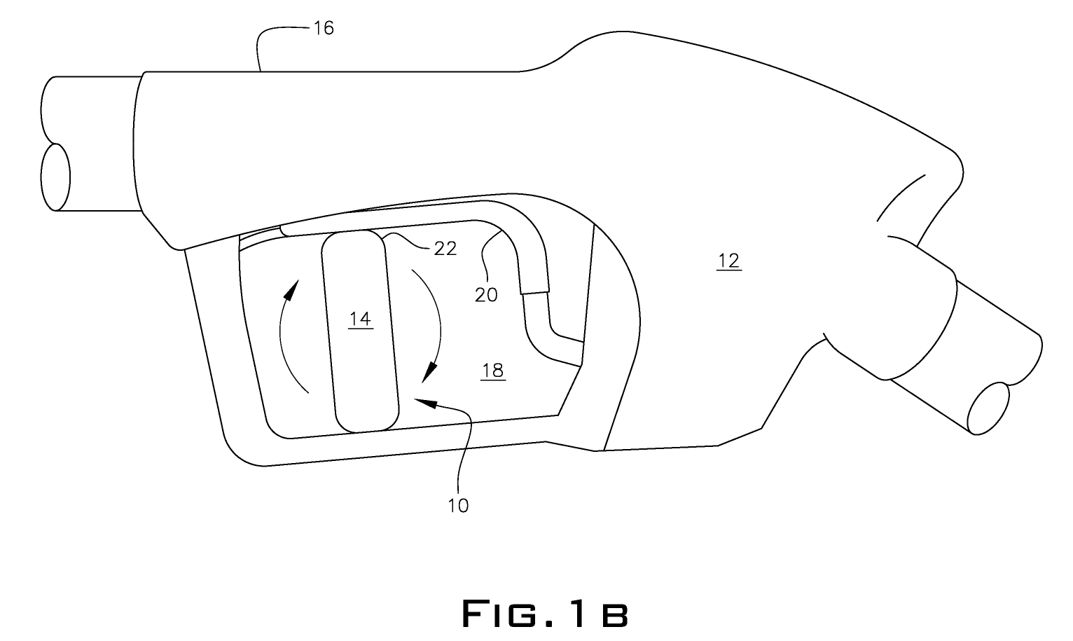

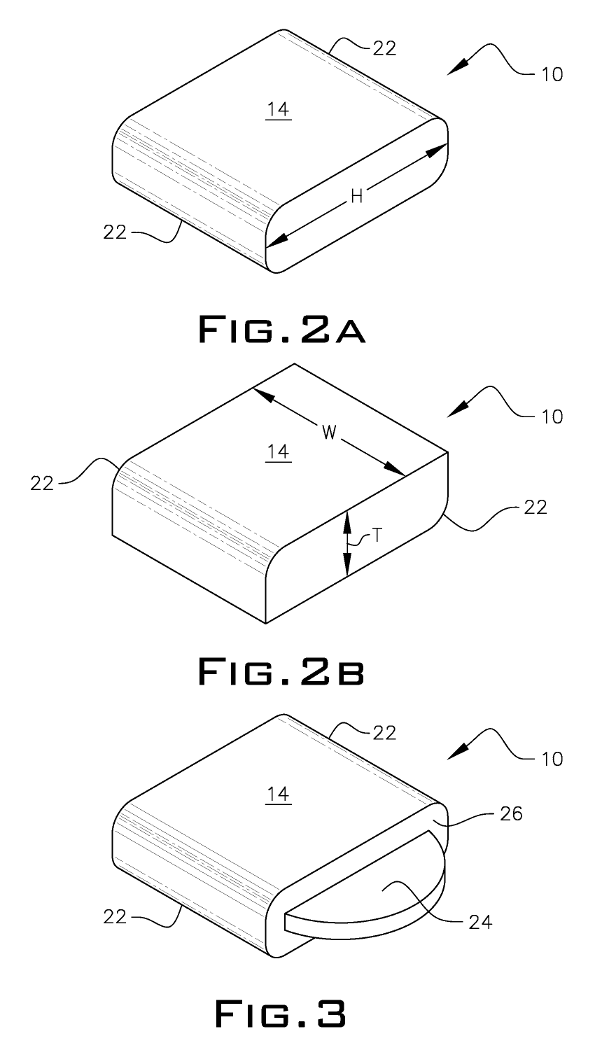

Referring now to the drawings, FIGS. 1A-1B, 2A-2B and 3 disclose representative examples of the use and configuration of the present invention, which is a gas pump handle block, depicted generally as 10.

The present invention is a gas pump nozzle handle block 10 for use in maintaining the nozzle valve 12 in an open flow position until the nozzle valve 12 senses the back pressure to shut off the flow of gas through the nozzle valve 12. The block 10 comprises a member 14 that has a predetermined width “W”, height “H” and thickness “T” wherein the predetermined height and thickness are dimensioned so as to slide within an opening of a gas pump nozzle handle 16, and rotated within the opening 18 so as to frictionally engage a bottom side of said member 14 against an upper side of the nozzle handle 16 below the opening 18 of the gas pump nozzle handle 16 and to further frictionally engage an upper side of the member 14 against an undersurface of a nozzle valve operating lever 20 and to push the lever 20 toward a lower side of the nozzle handle 16 above the opening 18 of the gas pump nozzle handle 16, therein providing the means for maintaining the operating lever 20 in an open flow position until the nozzle valve 12 senses a back pressure to shut off a flow of gas through the nozzle valve 12. One example of the overall dimensions of such a block or member 14 is a width of about 2 inches, a height of about 2⅜ inches and a thickness of about ¾ inch. Other dimensions are readily understood as long as the finished product is capable of performing the intended use with gas pump nozzles typical of those used at gas filling stations.

In a preferred embodiment, the member 14 has at least one pair of diagonally opposing rounded corners 22. The rounded corners 22 are formed to frictionally engage respective sides of the undersurface of a nozzle valve operating lever 20 and the upper side of the nozzle handle 16 below the opening 18 of the gas pump nozzle handle 16. Optionally, the member 14 can be formed to be more universal by having two pairs of diagonally opposing rounded corners 22. Preferably the corners can have an approximate ¼ inch radius but other radii such as about ⅛ inch to about ½ inch are also contemplated. The rounded corners 22 are formed so that upon flipping or rotating of the block 10, to frictionally engage respective sides of the undersurface of a nozzle valve operating lever 20 and the upper side of the nozzle handle 16 below the opening 18 of the gas pump nozzle handle 16. Optionally, the member 14 can be formed to be more universal by having two pairs of diagonally opposing rounded corners 22.

The block 10 can be made from a variety of durable materials known in the art such as those materials selected from the group consisting of wood material, plastic material, fiberglass material, and composite polymeric material. The preferred material is that material that can form the block 10 using an injection molded process to facilitate mass production. Due to the nature of the intended use, it is preferred that any material selected be static free, that is, have non-static characteristics for obvious safety reasons.

An optional embodiment is the providing of handle means extending from one side edge 26 of the block 10 for facilitating an insertion of the block 10 within the opening 18 of the gas pump nozzle handle 16 and for further facilitating a rotation and frictional engagement of the block 10 within the opening 18 of the gas pump nozzle handle 16. Handle 26 can be shaped in almost any manner as long as it allows for finger gripping for maneuvering the block 10 in place to be used. The depicted handle is merely an example. It can have a flat tab type of feature, a T-shaped feature or other designs known in the art that will facilitate placement of the block 10 within the opening 18 and rotating the block in position.

The invention further includes the method of use of the block 10, that is, the method of maintaining a gas pump nozzle valve 12 in an open flow position until the nozzle valve 12 senses a back pressure to shut off the flow of gas through the nozzle valve 12. The method comprises:

providing a gas pump nozzle handle block 10 as described above for use in maintaining the nozzle valve 12 in an open flow position until the nozzle valve 12 senses a back pressure to shut off the flow of gas through the nozzle valve 12; and

inserting the member 14 within the opening 18 of the gas pump nozzle handle 16 and rotating and frictionally engaging the member 14 within the opening 18 of the gas pump nozzle handle 16 between the upper side of the nozzle handle 16 below the opening 18 of the gas pump nozzle handle 16 and an undersurface of a nozzle valve operating lever 20 and to push the lever 20 toward a lower side of the nozzle handle 16 above the opening 18 of the gas pump nozzle handle 16 to maintain the operating lever 20 in an open flow position until the nozzle valve 12 senses a back pressure to shut off a flow of gas through the nozzle valve 12.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A gas pump nozzle handle block for use in maintaining the nozzle valve in an open flow position until the nozzle valve senses the back pressure to shut off the flow of gas through the nozzle valve, the block comprising:
a member having a predetermined width, height and thickness wherein said predetermined height and thickness are dimensioned so as to slide within an opening of a gas pump nozzle handle, and rotated within said opening so as to frictionally engage a bottom side of said member against an upper side of said nozzle handle below said opening of said gas pump nozzle handle and to further frictionally engage an upper side of said member against an undersurface of a nozzle valve operating lever and to push said lever toward a lower side of said nozzle handle above said opening of said gas pump nozzle handle, thereby maintaining said operating lever in an open flow position until said nozzle valve senses a back pressure to shut off a flow of gas through said nozzle valve.

2. The gas pump nozzle handle block according to claim 1, wherein said member has at least one pair of diagonally opposing rounded corners, wherein said rounded corners frictionally engage said respective side of said undersurface of a nozzle valve operating lever and said upper side of said nozzle handle below said opening of said gas pump nozzle handle.

3. The gas pump nozzle handle block according to claim 2, wherein said member has two pairs of diagonally opposing rounded corners.

4. The gas pump nozzle handle block according to claim 1, wherein said member is made from material selected from the group consisting of wood material, plastic material, fiberglass material, and composite polymeric material.

5. The gas pump nozzle handle block according to claim 1, further comprising:
handle means extending from one side edge of said member for facilitating an insertion of said member within said opening of said gas pump nozzle handle and for further facilitating a rotation and frictional engagement of said member within said opening of said gas pump nozzle handle.

6. A method of maintaining a gas pump nozzle valve in an open flow position until the nozzle valve senses a back pressure to shut off the flow of gas through the nozzle valve, the method comprising:
providing a gas pump nozzle handle block for use in maintaining said nozzle valve in an open flow position until the nozzle valve senses a back pressure to shut off the flow of gas through the nozzle valve, the block comprising:
a member having a predetermined width, height and thickness wherein said predetermined height and thickness are dimensioned so as to slide within an opening of a gas pump nozzle handle, and rotated within said opening so as to frictionally engage a bottom side of said member against an upper side of said nozzle handle below said opening of said gas pump nozzle handle and to further frictionally engage an upper side of said member against an undersurface of a nozzle valve operating lever and to push said lever toward a lower side of said nozzle handle above said opening of said gas pump nozzle handle; and
inserting said member within said opening of said gas pump nozzle handle and rotating and frictionally engaging said member within said opening of said gas pump nozzle handle between said upper side of said nozzle handle below said opening of said gas pump nozzle handle and an undersurface of a nozzle valve operating lever and to push said lever toward a lower side of said nozzle handle above said opening of said gas pump nozzle handle to maintain said operating lever in an open flow position until said nozzle valve senses a back pressure to shut off a flow of gas through said nozzle valve.

7. The method according to claim 6, wherein said member has at least one pair of diagonally opposing rounded corners, wherein said rounded corners frictionally engage said respective side of said undersurface of a nozzle valve operating lever and said upper side of said nozzle handle below said opening of said gas pump nozzle handle.

8. The method according to claim 7, wherein said member has two pairs of diagonally opposing rounded corners.

9. The method according to claim 6, wherein said member is made from material selected from the group consisting of wood material, plastic material, fiberglass material, and composite polymeric material.

10. The method according to claim 6, further comprising:
handle means extending from one side edge of side member for facilitating an insertion of said member within said opening of said gas pump nozzle handle and for further facilitating said rotation and frictional engagement of said member within said opening of said gas pump nozzle handle.
